(19) United States
(12) Patent Application Publication
(10) Pub. No.: US 2025/0189470 A1
(43) Pub. Date: Jun. 12, 2025

(54) THERMAL ANALYSIS APPARATUS AND CONTROL SOFTWARE FOR THERMAL ANALYSIS APPARATUS

(71) Applicant: Rigaku Corporation, Tokyo (JP)

(72) Inventors: Koichiro NORITAKE, Tokyo (JP); Shuichi MATSUO, Tokyo (JP)

(73) Assignee: Rigaku Corporation, Tokyo (JP)

(21) Appl. No.: 19/060,093

(22) Filed: Feb. 21, 2025

Related U.S. Application Data
(63) Continuation of application No. PCT/JP2023/030116, filed on Aug. 22, 2023.

(30) Foreign Application Priority Data
Aug. 23, 2022 (JP) 2022-132341

(51) Int. Cl. G01N 25/20

(52) U.S. Cl. CPC G01N 25/20

(57) ABSTRACT

Provided is a thermal analysis apparatus with which it is possible to easily perform detailed analysis of a change in the state of a sample, while visually grasping in detail the color of a sample and a change therein which accompanies a change in the temperature of the sample. Also provided is a thermal analysis apparatus which acquires thermal analysis data by measuring and calculating physical properties of a sample while changing temperature of the sample by heating or cooling and acquires image data by imaging the sample. Additionally, the apparatus is configured to display a graph of the thermal analysis data relating to temperature or time, a sample image of the sample data, color information data of range and type selected from the sample image, and a gradation in which colors generated from the color information data are arranged in correspondence with temperature or time, on a display.

### CROSS-REFERENCE TO RELATED APPLICATIONS

This application is a continuation of International Patent Application No. PCT/JP2023/030116, filed Aug. 22, 2023, and claims the benefit of Japanese Patent Application No. 2022-132341, filed Aug. 23, 2022, the entire contents of each are incorporated herein by reference.

### TECHNICAL FIELD

The present disclosure relates to thermal analysis apparatuses and, in particular, to a thermal analysis apparatus with a sample observation function and a control software for it.

### BACKGROUND ART

Thermal analysis is defined as “a series of techniques to measure certain physical properties of a substance (including its reaction products) as a function of temperature or time while the temperature of the substance is varied by a constant program. Thermal analysis includes Thermogravimetry (TG), which measures the change in mass of a sample while the sample is heated or cooled and the temperature is changed; Differential Thermal Analysis (DTA), which measures the temperature difference between a sample and a reference material; Differential Scanning calorimetry (DSC), which measures the heat flow difference between a sample and a reference material; Thermomechanical Analysis (TMA), which measures dimensional changes in a sample; and other techniques, depending on the type of sample and the purpose of the measurement.

Japanese Patent Application Publication No. 2021-001870 (Patent Literature 1) discloses a thermal analysis apparatus for measuring thermal behavior accompanying temperature changes of a sample in a heating furnace, which is provided with an aperture in the furnace for observing the sample and with an imaging means for capturing image data of the sample through the aperture. This thermal analysis apparatus superimposes color information generated from the image data, along with the thermal behavior of the sample as its temperature changes, on the temperature. Specifically, a graph of TG data and a graph of R, G and B values are superimposed and displayed with temperature as the horizontal axis.

However, the color information data, such as RGB values, and the graphs displayed by the thermal analysis device of Patent Document 1 do not allow a human to visually determine the actual color of the sample, and therefore make it impossible to visually grasp the color of the sample and its changes associated with temperature changes. Furthermore, when a graph of thermal analysis data and a graph of color information data are displayed overlapping each other, it is difficult to distinguish and analyze each graph, and because there are multiple vertical axes, it is difficult to know which vertical axis corresponds to which graph.

### RELATED ART DOCUMENT

### Patent Literature

Patent Literature 1: Japanese Patent Application Publication No. 2021-001870

### SUMMARY

### Technical Problem

An object of the present disclosure is to provide a thermal analysis apparatus and control software for a thermal analysis apparatus that enables easy and detailed analysis of changes in the state of a sample while visually grasping in detail the color and changes in the color of the sample that accompany changes in the temperature of the sample.

### Solution to Problem

In some implementations of the present disclosure, a thermal analysis apparatus measures and calculates physical properties of a sample while changing temperature of the sample by heating or cooling it to obtain thermal analysis data and photographs the sample to obtain image data. The apparatus includes a thermal analysis graph display means for displaying a graph of the thermal analysis data relating to temperature or time on a display, a sample image display means for displaying a sample image of the sample data on the display, a color information generation means for generating color information data of range and type selected from the sample image, and a gradation display means for displaying on the display a gradation in which colors generated from the color information data are arranged in correspondence with temperature or time.

The thermal analysis apparatus of the present disclosure may include a color information graph display means for displaying a graph of the color information data relating to temperature or time side by side with the graph of the thermal analysis data relating to temperature or time without superimposing both graphs on the display.

In the thermal analysis apparatus of the present disclosure, the color information generating means may select one or more ranges for generating color information data from the sample image.

In the thermal analysis apparatus of the present disclosure, the gradation display means may display a gradation in which colors generated from the color information data are arranged in correspondence with temperature or time as a strip-shaped color bar on the display.

According to another aspect of the present disclosure, a control software is provided for a thermal analysis apparatus that measures and calculates physical properties of a sample while changing temperature of the sample by heating or cooling it to obtain thermal analysis data and photographs the sample to obtain image data. The software causes a computer controlling the thermal analysis apparatus to function as follows: a thermal analysis graph display means for displaying a graph of the thermal analysis data relating to temperature or time on a display, a sample image display means for displaying a sample image of the sample data on the display, a color information generation means for generating color information data of range and type selected from the sample image, and a gradation display means for displaying on the display a gradation in which colors generated from the color information data are arranged in correspondence with temperature or time.

The present disclosure is not limited to the aforementioned purposes or aspects. A more complete appreciation of the disclosure and many of the attendant advantages thereof will be readily obtained as the same becomes better understood by reference to the following detailed description when considered in connections with the accompanying drawings.

### BRIEF DESCRIPTION OF DRAWINGS

FIG. 1 is an external view showing general arrangement of a thermal analysis apparatus according to an embodiment of the present disclosure;

FIG. 2 is a cross-sectional view of a heating furnace and its surroundings of the thermal analysis apparatus, with hatching partially omitted;

FIG. 3 is a block diagram showing the control and processing system of the thermal analysis apparatus;

FIG. 4 is an example of a flowchart for acquiring thermal analysis data and image data by the thermal analysis apparatus;

FIG. 5 is an example of a flowchart for displaying thermal analysis data, image data, etc. in a graph, etc. by the thermal analysis apparatus;

FIG. 6 is a graph of thermal analysis data (DSC data) and sample images of the desired points on the graph, displayed by the thermal analysis apparatus;

FIG. 7 is a diagram showing a screen for selecting a range for generating color information data from a sample image by a color information generation means of the thermal analysis apparatus;

FIG. 8 is a table showing an example of color information data generated by the color information generation means of the thermal analysis apparatus;

FIG. 9 is a diagram showing color information graphs displayed by a color information graph display means of the thermal analysis apparatus;

FIG. 10 is a table showing an example of colors generated by a gradation generation means of the thermal analysis apparatus;

FIG. 11 is a diagram showing an example of a gradation in which colors generated by a gradation display means according to an embodiment of the present disclosure are arranged in correspondence with time; and

FIG. 12 is a diagram showing a graph of thermal analysis data, a sample image of the desired point on the graph, a graph of color information data, and a color gradation displayed by the thermal analysis apparatus according to an embodiment of the present disclosure.

### DETAILED DESCRIPTION

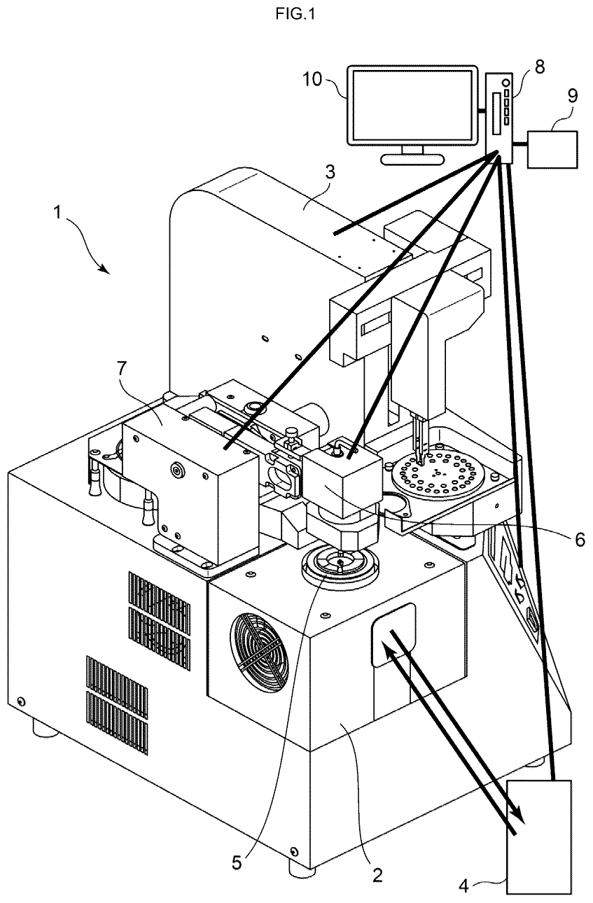

As a thermal analysis apparatus according to a first embodiment of the present disclosure, a differential scanning calorimetry (DSC) apparatus with a sample observation function is described. Referring to FIG. 1, a thermal analysis apparatus 1 includes a differential scanning calorimetry (DSC) apparatus 2, an automatic sample changer 3, a cooling unit 4, a lid unit 5 with observation windows, a camera 6, a camera moving mechanism 7, a computer 8, an input device 9, and a display 10. The computer 8 is installed with software 30 for controlling the thermal analysis apparatus 1, which will be described later.

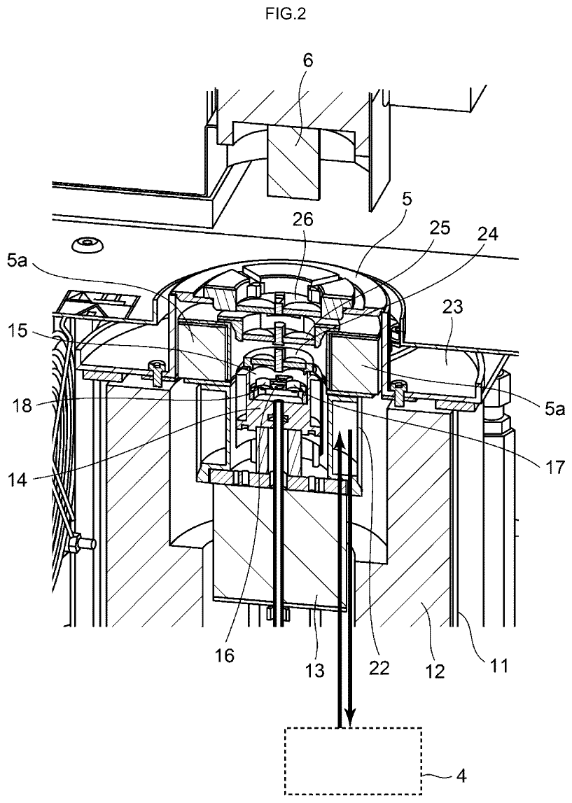

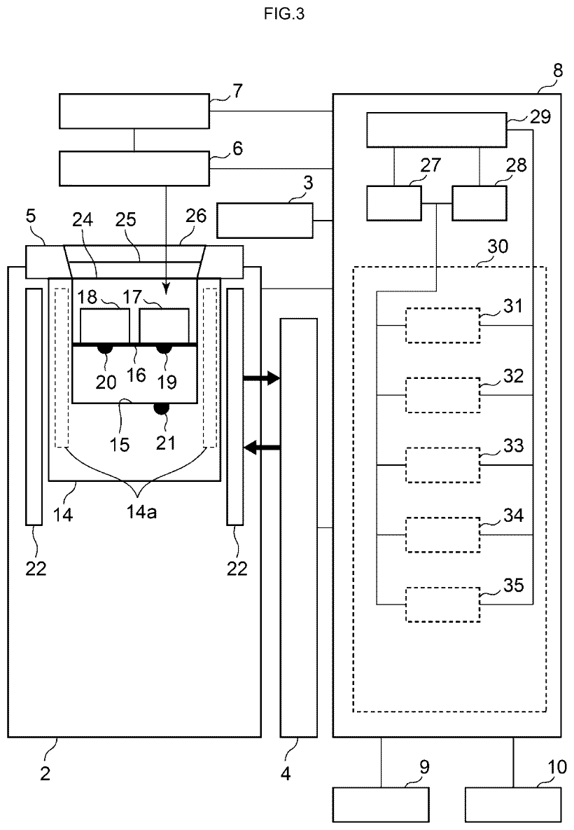

Referring to FIG. 2, the DSC apparatus 2 has a heating furnace 14 surrounded on its sides and bottom by heat insulators 12 and 13 in a cylindrical case 11. The heating furnace 14 includes a measurement chamber 15 with an open top surface and a heat sensitive plate 16 provided inside the measurement chamber 15. A sample container 17 on which a sample is placed is arranged at a predetermined sample measurement position on the heat sensitive plate 16. A sample container 18 on which a reference material is placed is arranged at a predetermined reference material measurement position on the heat sensitive plate 16. Referring to FIG. 3, a heater 14a that generates heat when energized is provided in the side wall of the heating furnace 14. The heating furnace 14 heats the sample and reference material in the measurement chamber 15 when the heater 14a generates heat.

Referring to FIG. 3, a sample temperature detecting means 19 such as a thermocouple is provided at the predetermined sample measurement position of the heat sensitive plate 16 to detect the temperature in contact or proximity to a bottom of the sample container 17. A reference material temperature detecting means 20 such as a thermocouple is provided at the predetermined reference material measurement position of the heat sensitive plate 16 to detect the temperature in contact or proximity to a bottom of the sample container 18. A heating furnace temperature detecting means 21 such as a thermocouple is provided at a bottom of the measurement chamber 15 of the heating furnace 14 to detect the temperature of the heating furnace 14. The DSC apparatus 2 converts the temperatures detected by the sample temperature detecting means 19, the reference material temperature detecting means 20, and the heating furnace temperature detecting means 21 into a sample temperature signal, a reference material temperature signal, and a heating furnace temperature signal, respectively. The DSC apparatus 2 saves the signals in a storage unit provided in the DSC apparatus 2 and transmits the signals to the computer 8 by wireless or wired communication.

Referring to FIGS. 2 and 3, a refrigerant jacket 22 connected to the cooling unit 4 by two conduits is provided around the outer circumference of the heating furnace 14. The cooling unit 4 circulates a cooling medium such as liquid nitrogen between an inside of the coolant jacket 22 and the cooling unit 4 to cool the sample and the reference substance in the heating furnace 14 and the measurement chamber 15.

The lid unit 5 with observation windows is provided on a case lid 23, which closes an upper surface of the case 11. The lid unit 5 with observation windows has an inner lid 24 with an observation window that is removably attached to the heating furnace 14, a middle lid 25 with an observation window that is removably attached to a spacer 5a installed on the case lid 23, and an outer lid 26 with an observation window that is removably attached to the lid unit 5 so that the top opening of the measurement chamber 15 can be opened and closed. The reason for having three lids with observation windows is to prevent condensation from forming on the observation windows when they are cooled by the cooling unit 4, for example. When measuring, all lids 24, 25 and 26 with observation windows are attached to the lid unit 5 and the top opening of the measurement chamber 15 is closed.

The DSC apparatus 2 is a heat flux type differential scanning calorimetry system. Differential scanning calorimetry (DSC) is “a method of measuring the temperature of both a reference material and a sample while applying a constant heat, and quantitatively measuring the endotherm and exotherm due to changes in the state of the sample. The reference material is made of thermally stable material and does not change its physical properties such as melting and evaporation even if the temperature changes. In contrast, when the sample undergoes an endothermic or exothermic reaction in response to a temperature change according to its own characteristics, the temperature change stops during the reaction and a temperature difference ΔT is generated between the sample and the reference material. Heat flow to mitigate this temperature difference ΔT flows into the sample through the heat sensitive plate 16. Heat quantity per unit time (heat flow) that flows into the sample is proportional to the temperature difference ΔT between the sample and the reference material. Therefore, the heat quantity (energy) of the sample is obtained by integrating the temperature difference ΔT with respect to time, correcting the value in consideration of the temperature dependence, and dividing the corrected value by the apparatus constant K. In this way, the heat flux flowing into the sample, and thus the heat quantity, is calculated based on the temperature difference between the sample and the reference material. The calculated heat quantity is a thermal analysis data (DSC data) obtained by differential scanning calorimetry (DSC) of the sample.

Referring to FIGS. 1 to 3, the camera 6 captures images of the sample on the sample container 17 arranged at the predetermined sample measurement position in the measurement chamber 15 through the observation windows of the three lids 24, 25 and 26 of the lid unit 5. The image data of the sample taken by the camera 6 is stored in the memory unit provided in the camera 6 or the camera moving mechanism 7 and is also transmitted to the computer 8.

The camera moving mechanism 7 adjusts the position of the sample to be photographed by the camera 6. When the lids 24, 25 and 26 with observation windows are removed from the lid unit 5 and the sample or reference material is placed or replaced in the measurement chamber 15, the camera 6 pivotally supported by the camera moving mechanism 7 on a horizontal axis rotates upward and backward and retreats from an area around the lid unit 5.

The automatic sample changer 3 is activated when the camera 6 pivotally supported by the camera moving mechanism 7 rotates upward and backward and retreats and the lids 24, 25 and 26 with observation windows are removed from the lid unit 5. The sample changer 3 can make the sample container 17 carrying the sample to be placed at or removed from the predetermined sample measurement position through the top opening of the measurement chamber 15. The automatic sample changer 3 may further be capable to make the sample container 18 carrying the reference material to be placed at or removed from the predetermined reference material measurement position.

Referring to FIG. 3, the computer 8 is installed with the control software 30 for the thermal analysis apparatus according to an embodiment of the present disclosure. The computer 8 includes a central processing unit (CPU) 27, a graphic processing unit (GPU) 28, a memory device 29 such as HDD, SSD and the like. The computer 8 transmits and receives various signals through wired or wireless communication with the DSC apparatus 2, the automatic sample changer 3, the cooling unit 4, the camera 6, the camera moving mechanism 7, the input device 9, and the display 10.

The input device 9 is a device for the operator to input sample measurement conditions and operating instructions for each device into the computer 8. The input device 9 consists of a keyboard and mouse but may also include a touch panel and voice input means.

The display 10 displays various types of information according to control by the software 30 installed in the computer 8 or input from the input device 9. The display 10 consists of a liquid crystal monitor or the like.

The thermal analysis apparatus 1 is controlled by the computer 8 with the software 30 installed, heats the sample by the heating furnace 14 or cools it by the cooling unit 4 to change the temperature of the sample in the measurement chamber 15, while measuring and calculating the physical properties of the sample to obtain thermal analysis data, and captures images of the sample with the camera 6 to obtain image data.

The computer 8 installed with the software 30 has a configuration and functions as thermal analysis graph display means 31 for displaying a graph of the thermal analysis data related to temperature or time on the display 10.

The computer 8 installed with the software 30 has a configuration and functions as sample image display means 32 for displaying a sample image of the image data on the display 10.

The computer 8 installed with the software 30 has a configuration and functions as color information generating means 33 for generating a color information data of the range and type selected from the sample image.

The computer 8 installed with the software 30 has a configuration and functions as color information graph display means 34 for displaying a graph of the color information data relating to temperature or time side by side with the graph of the thermal analysis data relating to temperature or time without superimposing both graphs on the display 10.

The computer 8 installed with the software 30 has a configuration and functions as gradation display means 35 for displaying on the display 10 a gradation in which colors generated from the color information data are arranged in correspondence with temperature or time.

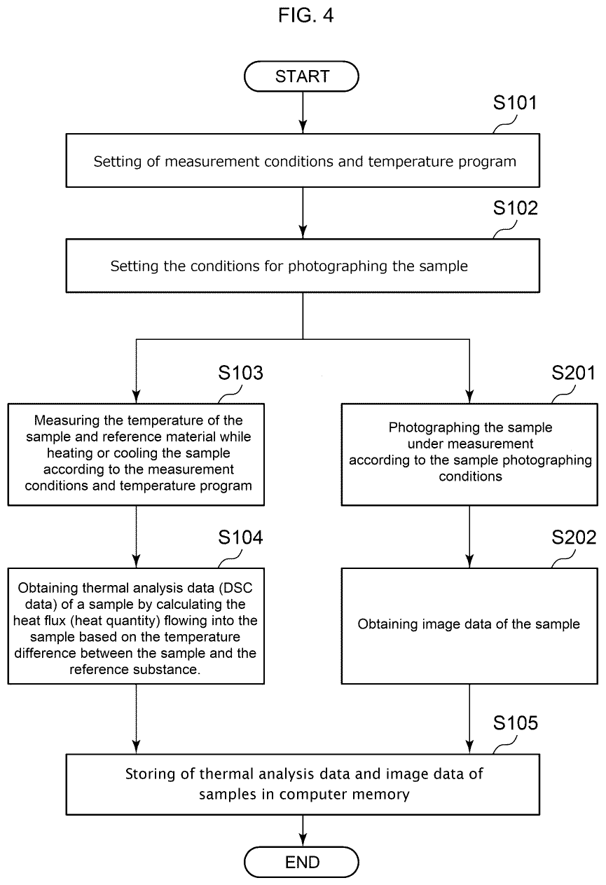

Referring to FIG. 4, the following description relates to an example of a flowchart for acquiring thermal analysis data and image data of a sample using the thermal analysis apparatus according to an embodiment of the present disclosure.

In step S101, a measurement condition and temperature program setting screen of the thermal analysis apparatus 1 is opened, and a sample name, sample weight, set temperature range, measurement time, measurement interval, etc. are set by inputting them into the computer 8 using the input device 9.

In step S102, a sample imaging condition setting screen of the thermal analysis apparatus 1 is opened, and imaging time, imaging interval, etc. are set by inputting them into the computer 8 using the input device 9.

In step S103, the measurement is started, and the temperature is controlled by the computer 8 with the software 30 installed according to the predetermined measurement conditions and the predetermined temperature program. Specifically, the heater 14a is energized to generate heat, and the heating furnace 14 heats the sample placed on the sample container 17 arranged at the predetermined sample measurement position in the measurement chamber 15. Alternatively, the cooling unit 4 circulates a cooling medium to and from the inside of the refrigerant jacket 22 through two conduits to cool the furnace 14 and the sample placed on the sample container 17 placed at the predetermined sample measurement position in the measurement chamber 15. Then, the sample temperature detecting means 19 measures the temperature of the sample and the reference material temperature detecting means 20 measures the temperature of the reference material, according to predetermined measurement conditions such as measurement intervals.

In step S104, computer 8 calculates the heat flux, or heat quantity, flowing into the sample based on the temperature difference between the measured sample temperature and the reference material temperature to obtain thermal analysis data (DSC data) for the sample.

In step S201, photographing is performed under the control of the computer 8 installed with the software 30 according to predetermined sample photographing conditions. Specifically, the camera 6 of the thermal analysis apparatus 1 photographs the sample placed on the sample container 17 arranged at the predetermined sample measurement position in the measurement chamber 15 during the measurement.

In step S202, the computer 8 obtains image data of the sample being measured.

In step S105, the thermal analysis data and the image data of the sample acquired by the computer 8 are stored in the memory device 29 of the computer 8.

The following description relates to an example of a flowchart for displaying graphs of thermal analysis data and image data using the thermal analysis apparatus according to an embodiment of the present disclosure in order to analyze state changes associated with temperature changes of the sample.

Referring to FIG. 5, in step S301, the thermal analysis apparatus 1, which is controlled by the computer 8 with the software 30 installed, measures and calculates the physical properties of the sample in the measurement chamber 15, while changing the temperature of the sample by heating it with the heating furnace 14 or cooling it with the cooling unit 4, so as to obtain thermal analysis data, and photographs the sample with the camera 6 during the measurement to obtain image data. For example, the sample can be measured and photographed according to the flowchart shown in FIG. 4 to obtain thermal analysis data and image data. The thermal analysis data and image data may also be acquired by reading the data stored in the memory device 29 of the computer 8.

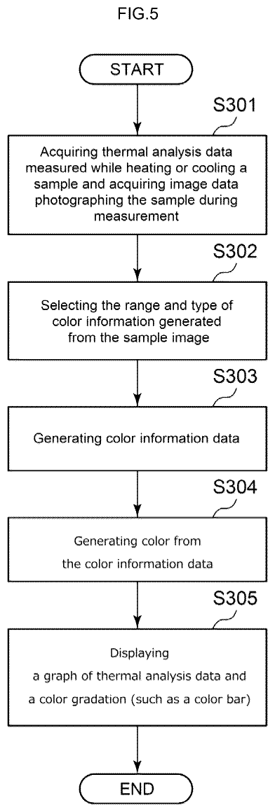

FIG. 6 shows an example of a graph of DSC data obtained by measuring the temperature of a sample and the temperature of a reference material in the process of raising the temperature of the sample to 80° C. and then lowering it to −50° C., and then calculating based on the temperature difference between the sample and the reference material. Specifically, a graph of the sample related to temperature and time is displayed by the thermal analysis graph display means 31, with the horizontal axis representing time (Time; unit: minutes (min.)) and the vertical axis representing temperature (Temperature; unit: ° C.). A graph of the sample related to heat flow and time is also displayed with the horizontal axis representing time (Time, unit: min.) and the vertical axis representing heat flow (Heat Flow, unit: milliwatt (mW)).

In FIG. 6, the sample image display means 32 displays a sample image of an arbitrarily selected point on a graph of heat analysis data (DSC data) with respect to heat flow and time. The sample image display means 32 can display multiple sample images on the display 10 by selecting multiple points on the graph of the thermal analysis data or by selecting multiple sample images from the image data stored in the memory device 29.

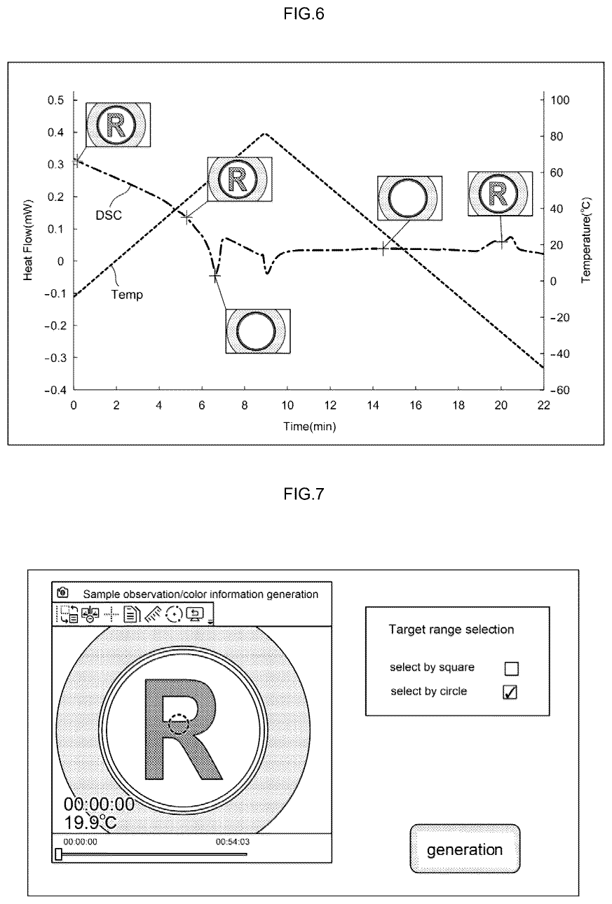

Referring to FIG. 5, in step S302, the color information generating means 33 can select the range and type of color information to be generated from the sample image. FIG. 7 shows an example of a sample observation color information window opened by the color information generating means 33 for selecting the range and type of color information to be generated from the sample image. The sample image is displayed in the sample observation color information window by the sample image display means 32. In the sample observation color information window shown in FIG. 7, there is a check box to select whether to “select by square” or “select by circle” as the range of color information to be generated from the sample image (target range). In FIG. 7, “Select by circle” is checked, so a dashed circle is displayed in the sample image displayed in the sample observation color information window. The size and position of the target area indicated by the dashed circle can be changed using an input device 9 such as a keyboard or mouse.

In FIG. 7, there is also a sample observation color information window for selecting the type of color information to be generated. The color information is information that quantifies the color of the image data captured by the camera 6. The types of color information to be generated can be selected from, for example: “RGB” that expresses colors by combining the “three primary colors of light (Red, Green, and Blue)”; “CMYK” that expresses colors by combining the “three primary colors of color (Cyan, Magenta, and Yellow)” and “black”; “CIE Lab” that is defined by the International Commission on Illumination (CIE); and “HSV” that expresses colors by combining “Hue, Saturation, and Value”.

Referring to FIG. 5, in step S303, the color information generating means 33 generates color information data for the range and type selected from the sample image. Referring to FIG. 7, when “Generate” displayed in the sample observation color information window is clicked with the mouse, the color information generating means 33 confirms the selection of the range and type of color information to be generated and generates color information data. FIG. 8 shows an example of color information data generated by the color information generating means 33 in a table. As shown in FIG. 8, thermal analysis data (Temp, DSC), image data (observed image), and color information data (R-values, G-values, B-values, etc.) are stored in correspondence with the measurement time (Time).

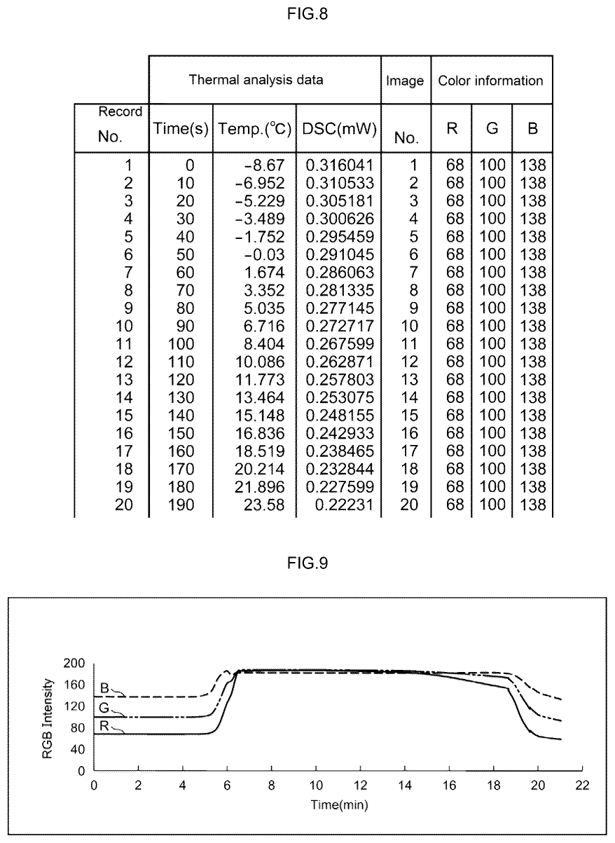

Referring to FIG. 5, in step S303, the color information graph display means 34 may further cause the display to display a graph of the color information data relative to temperature or time. FIG. 9 shows an example of a graph of the color information data, R-values, G-values, and B-values, relative to time, displayed by the color information graph display means 34. According to these graphs of color information, it can be understood that the color information changes significantly between 5 and 7 minutes after the start of measurement and between 14 and 20 minutes (especially around 19 minutes). Thus, according to the graphs of color information, it is possible to accurately grasp the timing and amount of color change of the samples. However, the graph of color information does not allow us to visually grasp the color of the sample and its change. In addition, the relationship with the sample temperature cannot be grasped.

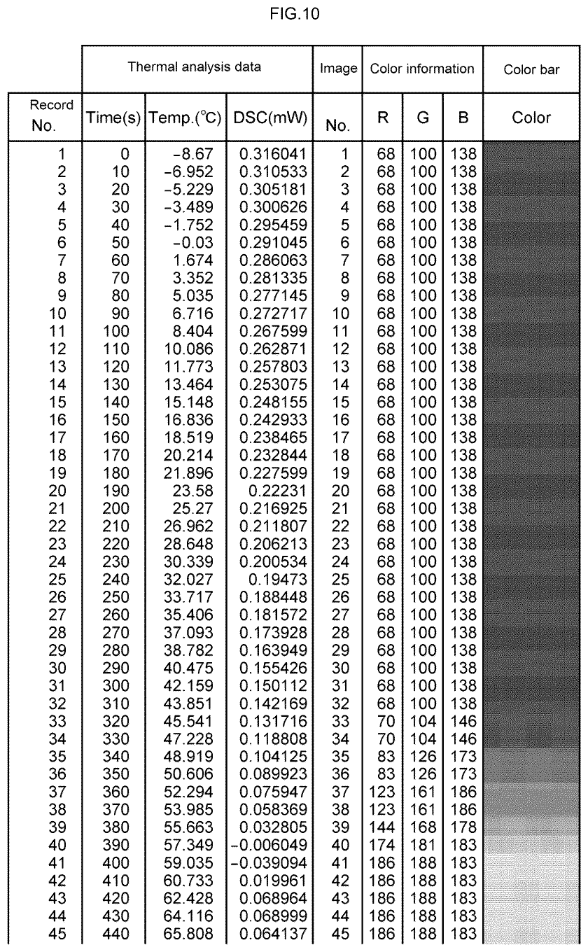

Referring to FIG. 5, in step S304, the gradation display means 35 generates a color from the color information data. In FIG. 10, the color generated by the gradation display means 35 from the R value, G value, and B value of the color information data is displayed in the “Color” column. As shown in FIG. 10, the thermal analysis data, the image data, the color information (R value, G value, B value), and the generated color are linked to the measurement time and the sample temperature at that time. Therefore, the generated color allows the color of the sample corresponding to each measurement time and sample temperature to be visually grasped.

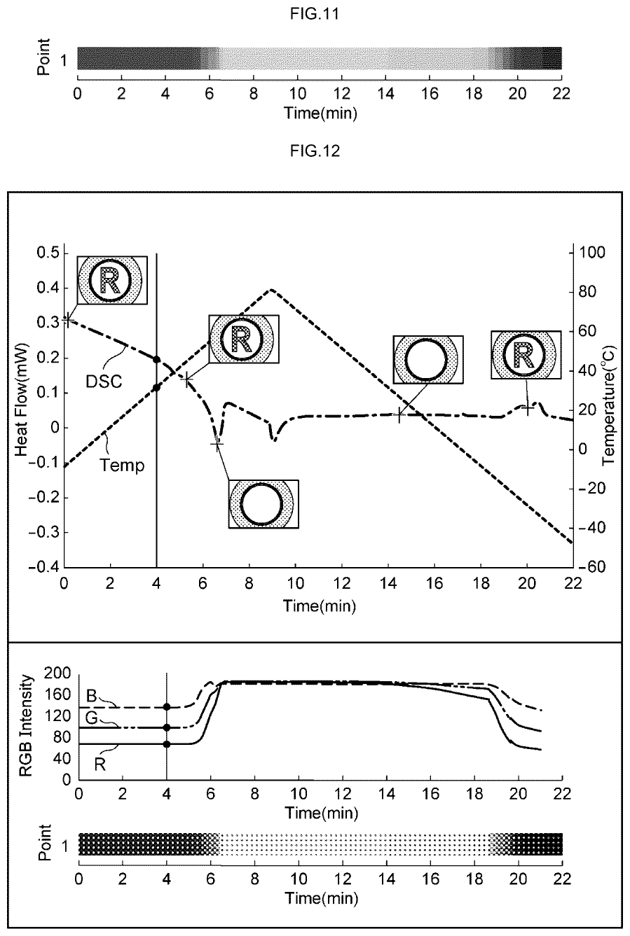

Referring to FIG. 5, in step S305, the gradation display means 35 displays on the display a gradation in which the generated colors are arranged in correspondence with temperature or time. FIG. 11 shows an example of a gradation in which the generated colors are arranged in correspondence with the measurement time. The gradation shown in FIG. 11 can be called a “color bar” because the gradation in which the colors generated from the color information data are arranged in correspondence with time is displayed in a strip or bar shape. According to the gradation or color bar shown in FIG. 11, the color of the sample was dark blue (dark in FIG. 11 which is shown in black and white) from the start of the measurement until about 5 minutes, changed from blue (dark) to gray (light) between about 5 minutes and 7 minutes, remained gray (light) from about 7 minutes to about 14 minutes, changed from gray (light) to blue (dark), and then changed drastically around 19 minutes, becoming dark blue (dark) from about 20 minutes onwards, allowing the change in color of the sample to be visually grasped in detail.

For example, FIG. 12 shows a graph of thermal analysis data (DSC data) measured by the thermal analysis apparatus 1 when paper on which letters were written with an erasable ballpoint pen was placed in the sample container and the temperature was increased at 10° C./min to 80° C. in an N2 atmosphere and then decreased to −50° C., with the horizontal axis representing time (measurement time). A graph (Temp) showing the relationship between time (measurement time) and sample temperature is also displayed.

FIG. 12 displays a graph of the thermal analysis data (DSC data) as well as sample images at five points on the graph of the thermal analysis data (DSC data). Although the display of sample images allows the user to grasp the actual color of the sample, it is difficult to evaluate local color changes of the sample or to compare and evaluate color changes at multiple locations due to the limited number of sample images that can be displayed.

In FIG. 12, a graph of the color information data (RGB values) generated from the character portion near the center of the sample image is displayed below the graph of the thermal analysis data (DSC data) without superimposition, with the horizontal axis representing the time from the start of measurement and the scale size also adjusted. Since the graph of thermal analysis data and the graph of color information data are displayed side by side without superimposition, each graph becomes easier to see and analyze. The graph of color information data (RGB values) allows the user to grasp the timing and amount of color change but does not allow the user to visually grasp the color of the sample or its change.

In FIG. 12, a gradation (color bar) of colors generated from color information data (RGB values) is displayed together with the graph of the thermal analysis data (DSC data), with the horizontal axis representing time from the start of measurement and the scale size also adjusted. The gradation (color bar) of colors generated from color information data (RGB values) allows the user to easily and in detail visually grasp the actual color of the sample and its changes. Therefore, by displaying the color change of the sample in a gradation (color bar) together with a graph of thermal analysis data, the color of the sample and the color change associated with temperature changes of the sample can be visually grasped in detail, and changes in the state of the sample can be easily and in detail analyzed.

The disclosure is not limited to the above embodiments, but also includes various variations and equivalents included within the scope of the disclosure and the technical concept of each component of the disclosure.

For example, the color information generating means 33 may be capable of selecting multiple ranges for generating color information data from the sample image. By selecting multiple ranges in the sample image and generating color information data for each range, color changes and the like can be compared and evaluated for multiple locations in the sample image.

The thermal analysis device of the present disclosure may not include a color information graph display means for displaying a graph of the temperature or time of the color information data on the display without superimposing it on the graph of the temperature or time of the thermal analysis data.

The gradation display means is not limited to displaying a gradation in which colors generated from the color information data are arranged in correspondence with temperature or time as a strip-shaped color bar on the display device. For example, the colors of the graph of the temperature or time of the thermal analysis data may be displayed as a gradation in which colors generated from the color information data are arranged in correspondence with temperature or time.

The thermal analysis apparatus of the present disclosure is not limited to consists of a plurality of apparatuses and/or devices such as a differential scanning calorimetry (DSC) apparatus, a cooling unit, a computer with control software installed, an input device, a display. The thermal analysis apparatus of the present disclosure may be configured integrally with a part or all of these apparatuses. The computer installed with control software may also control multiple differential scanning calorimetry (DSC) apparatus or other thermal analysis apparatus. A part or all of the control software may also be installed on a server on the cloud.

The thermal analysis apparatus of the present disclosure is not limited to differential scanning calorimetry (DSC) apparatus or TG-DTA apparatus, but may be thermogravimetry (TG) apparatus, differential thermal analysis (DTA) apparatus, thermomechanical analysis (TMA) apparatus, and various other thermal analysis apparatus.

### INDUSTRIAL APPLICABILITY

The present disclosure can be used to provide a thermal analysis apparatus that can easily and in detail analyze changes in the state of a sample while visually grasping in detail the color and changes in the color of the sample that accompany changes in the temperature of the sample, and control software for realizing such a thermal analysis apparatus.

### REFERENCE SIGNS LIST

1 thermal analysis apparatus
2 differential scanning calorimetry (DSC) apparatus
3 automatic sample changer
4 cooling unit
5 lid unit with observation windows
6 camera
7 camera movement mechanism
8 computer
9 input device
10 display
11 case
12, 13 heat insulation material
14 heating furnace
14a heater
15 measurement chamber
16 heat sensitive plate
17, 18 sample container
19 sample temperature detection means
20 reference material temperature detection means
21 heating furnace temperature detection means
22 refrigerant jacket
23 case lid
24 inner lid with observation window
middle lid with observation window
26 outer lid with observation window
27 central processing unit (CPU)
28 graphic processing unit (GPU)
29 memory device
30 control software
31 thermal analysis graph display means
32 sample image display means
33 color information generating means
34 color information graph display means
35 gradation display means

1. A thermal analysis apparatus that measures and calculates physical properties of a sample while changing temperature of the sample by heating or cooling it to obtain thermal analysis data and photographs the sample to obtain image data, the apparatus comprising:
processing circuitry configured to
display a graph of the thermal analysis data relating to temperature or time on a display;
display a sample image of the sample data on the display;
generate color information data of range and type selected from the sample image; and
display a gradation in which colors generated from the color information data are arranged in correspondence with temperature or time.

2. The thermal analysis apparatus according to claim 1, wherein the processing circuitry is further configured to
display a graph of the color information data relating to temperature or time side by side with the graph of the thermal analysis data relating to temperature or time without superimposing both graphs on the display.

3. The thermal analysis apparatus according to claim 1, wherein the processing circuitry is further configured to
select one or more ranges for generating color information data from the sample image.

4. The thermal analysis apparatus according to claim 1, wherein the processing circuitry is further configured to
display a gradation in which colors generated from the color information data are arranged in correspondence with temperature or time as a strip-shaped color bar on the display.

5. A non-transitory computer-readable storage medium for a thermal analysis apparatus that measures and calculates physical properties of a sample while changing temperature of the sample by heating or cooling it to obtain thermal analysis data and photographs the sample to obtain image data, storing computer-readable instructions thereon which, when executed by circuitry of the thermal analysis apparatus, causes the thermal analysis apparatus to perform a method, the method comprising:
displaying a graph of the thermal analysis data relating to temperature or time on a display;
displaying a sample image of the sample data on the display;
generating color information data of range and type selected from the sample image; and
displaying on the display a gradation in which colors generated from the color information data are arranged in correspondence with temperature or time.
